(19) United States
(12) Patent Application Publication
(10) Pub. No.: US 2026/0184014 A1
(43) Pub. Date: Jul. 2, 2026

(54) HEAD SET, 3D PRINTING DEVICE, AND 3D PRINTING METHOD

(71) Applicant: Shenzhen Creality 3D Technology Co., Ltd., Shenzhen (CN)

(72) Inventors: Dajiang WU, Shenzhen (CN); Weizhen LI, Shenzhen (CN); Jingke TANG, Shenzhen (CN)

(21) Appl. No.: 19/372,606

(22) Filed: Oct. 29, 2025

(30) Foreign Application Priority Data
Dec. 31, 2024 (CN) 202411998869.X

(51) Int. Cl. B29C 64/209; B22F 12/37; B22F 12/53; B22F 12/90; B29C 64/227; B29C 64/245; B29C 64/386; B33Y 10/00; B33Y 30/00; B33Y 40/00; B33Y 50/00

(52) U.S. Cl. CPC B29C 64/209; B22F 12/37; B22F 12/53; B22F 12/90; B29C 64/227; B29C 64/245; B29C 64/386; B33Y 30/00; B33Y 40/00; B33Y 10/00; B33Y 50/00

(57) ABSTRACT

This application discloses a head set, 3D printing device, and 3D printing method. The head set is configured to be driven to move along a force application direction. The head set includes a bracket, a nozzle assembly, and a sensor. The nozzle assembly is connected with the bracket and configured to be driven by an external force to move along the force application direction. The sensor connected with the bracket and/or the nozzle assembly, configured to sense displacement and/or deformation of the nozzle assembly.

### FIELD

The present disclosure relates to field of 3D printing, and in particular to a head set, a 3D printing device, and a 3D printing method.

### BACKGROUND

3D printing technology is a rapid prototyping technique that uses digital model files as the basis and special wax materials, powdered metals or plastics and other bondable materials to create three-dimensional objects by printing layer upon layer of materials. Fused Deposition Modeling (FDM) technology is one of the main 3D printing technologies. The FDM technology involves heating and melting the hot-melt consumable material filament, extruding melted material through a nozzle, and depositing the melted material on a forming platform or a previous layer of solidified material, ultimately generating a physical object.

During printing, consumable material is extruded from the nozzle, and a position accuracy of the nozzle is directly related to an accuracy of 3D printing. To ensure the accuracy of 3D printing, the position of the nozzle needs to be calibrated or determined. Driving the nozzle to contact external structures (such as a machine platform or forming platform) is a common practice for calibrating or determining the nozzle position, but how to promptly determine a contact time between the nozzle and the external structure is a consideration for those skilled in the art.

Thus, there is room for improvement within the art.

### BRIEF DESCRIPTION OF THE DRAWINGS

Many aspects of the disclosure can be better understood with reference to the following drawings. The drawings in the following description are some embodiments of the present disclosure. For those of ordinary skill in the art, other drawings can be obtained based on these drawings without creative work.

FIG. 1 is a perspective view of a head set provided by embodiments of the present application.

FIG. 2 is a sectional view of a part of the head set provided by an embodiment of the present application.

FIG. 3 is a perspective view of a part of a nozzle assembly of the head set provided by an embodiment of the present application.

FIG. 4 is a sectional view of a part of the head set provided by another embodiment of the present application.

FIG. 5 is a perspective view of a part of the head set provided by another embodiment of the present application.

FIG. 6 is a sectional view of a head set provided by another embodiment of the present application.

FIG. 7 is a sectional view of a head set provided by another embodiment of the present application.

FIG. 8 is a schematic view of a 3D printing device provided by embodiments of the present application.

### DETAILED DESCRIPTION

In order to make the above-mentioned objects, features and advantages of the present application more obvious, a detailed description of specific embodiments of the present application will be described in detail with reference to the accompanying drawings. A number of details are set forth in the following description so as to fully understand the present application. However, the present application can be implemented in many other ways different from those described herein, and those skilled in the art can make similar improvements without violating the contents of the present application. Therefore, the present application is not to be considered as limiting the scope of the embodiments described herein.

Several definitions that apply throughout this disclosure will now be presented.

The term “coupled” is defined as coupled, whether directly or indirectly through intervening components, and is not necessarily limited to physical connections. The connection may be such that the objects are permanently coupled or releasably coupled. The term “substantially” is defined to be essentially conforming to the particular dimension, shape, or other feature that the term modifies, such that the component need not have that exact feature. The term “comprising,” when utilized, means “including, but not necessarily limited to”; it in one embodiment indicates open-ended inclusion or membership in the so-described combination, group, series, and the like.

Unless otherwise defined, all technical and scientific terms used herein have the same meaning as commonly understood by one skilled in the art. The terms used in a specification of the present application herein are only for describing specific embodiments and are not intended to limit the present application. The terms “and/or” used herein includes any and all combinations of one or more of associated listed items.

As those skilled in the art can understand, “3D printing” refers to a technology that constructs objects layer by layer based on digital model files, using powdery metals or plastics and other bondable materials.

Embodiments of the application are described in detail below with reference to the drawings.

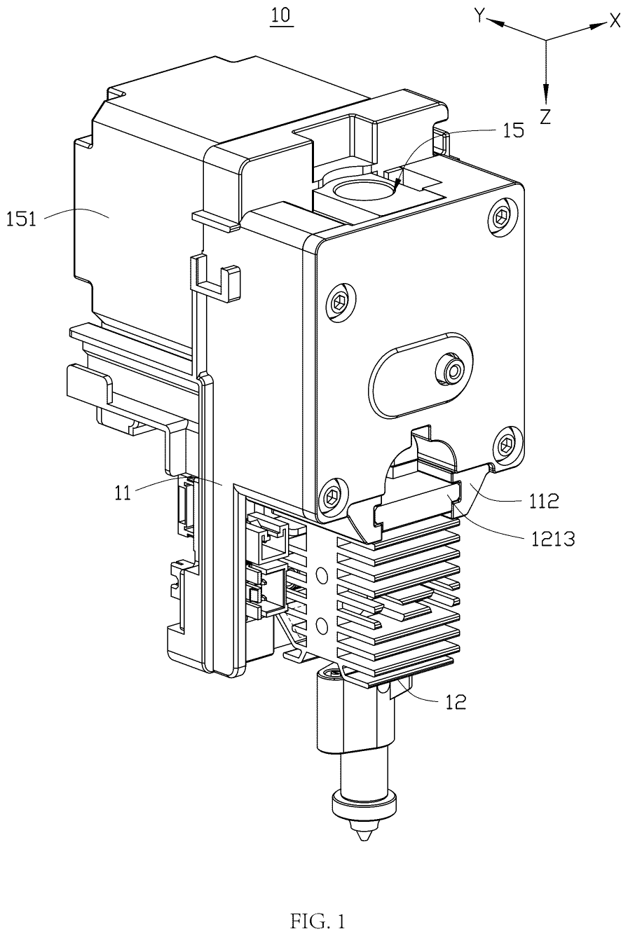

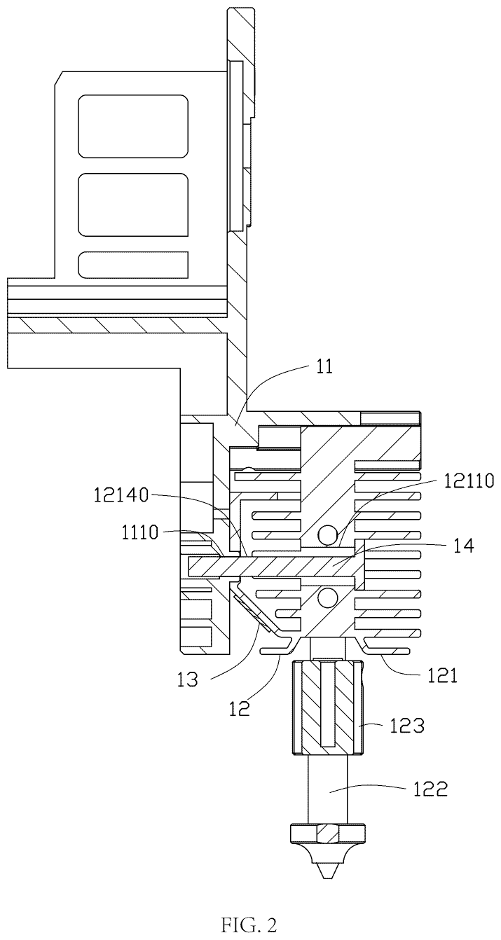

As shown in FIG. 1 to FIG. 3, embodiments of the present application provide a head set 10, the head set is able to be driven to move along a force application direction Z. The head set 10 includes a bracket 11, a nozzle assembly 12, and a sensor 13. The nozzle assembly 12 is connected with the bracket 11 and is able to be driven by an external force to move along the force application direction Z relative to the bracket 11. The sensor 13 is connected with the bracket 11 and/or the nozzle assembly 12, configured to sense displacement and/or deformation of the nozzle assembly 12.

The head set 10 provided by embodiments of the present application is able to be driven to move along a force application direction Z, configured for abutting against an external structure to calibrate or determine a position of the head set 10. When calibrating or determining the position of the nozzle assembly 12, the nozzle assembly 12 may be deformed under compression or displaced relative to the bracket 11 along the force application direction Z. The sensor 13 is connected with the bracket 11 and/or the nozzle assembly 12, configured to sense displacement and/or deformation of the nozzle assembly 12, thereby recording the contact time between the head set 10 and the external structure.

In some embodiments, a side view direction X, a sliding direction Y and the force application direction Z are introduced for description in the embodiments of the present application. The side view direction X, the sliding direction Y and the force application direction Z are three non-parallel directions in the spatial coordinate system. In subsequent embodiments, the side view direction X, the sliding direction Y and the force application direction Z are taken as three mutually perpendicular reference directions in the three-dimensional Cartesian coordinate system for description. The directions shown in the embodiments of this application are configured to help understand the mutual positional relationship of each component.

In an embodiment, the bracket 11 includes a plate portion 111 and a sliding portion 112, the plate portion 111 and the sliding portion 112 are connected to each other. The plate portion 111 is substantially plate-shaped, with a width direction of the plate portion 111 corresponding to the side view direction X, a thickness direction of the plate portion 111 corresponding to the sliding direction Y, and a length direction of the plate portion 111 corresponding to the force application direction Z. The sliding portion 112 is protruded on one side of the plate portion 111 along the sliding direction Y, and the sliding portion 112 and the plate portion 111 form a substantially angled structure, with a heat dissipation portion 121 being formed in the angled structure.

In an embodiment, the head set 10 further includes an extrusion assembly 15 connected with the bracket 11, the extrusion assembly 15 and the nozzle assembly 12 cooperate to complete the extrusion of consumables. The extrusion assembly 15 and the nozzle assembly 12 are arranged on opposite sides of the sliding portion 112 along the force application direction Z, the extrusion assembly 15 is supported by the sliding portion 112 along the force application direction Z. The nozzle assembly 12 is disposed on another side of the sliding portion 112 along the force application direction Z and connected with the plate portion 111 and the heat dissipation portion 121, to enhance the connection strength of the nozzle assembly 12, preventing position deviation of the nozzle assembly 12 when the nozzle assembly 12 abuts against the external structure along the force application direction Z.

In an embodiment, the extrusion assembly 15 is at an upstream of the transmission channel 100, configured to grip and push the consumables into the nozzle assembly 12. The extrusion assembly 15 includes an extrusion drive portion 151 and an extrusion wheel set (not shown in the figure), the extrusion drive portion 151 is configured to generate rotational torque and may be a drive motor, the extrusion wheel set includes at least a drive wheel and a driven wheel. The drive wheel is drivingly connected with the extrusion drive portion 151, the driven wheel is transmission-connected with the drive wheel, and multiple drive wheels and/or multiple driven wheels cooperate to grip and push the consumables.

In an embodiment, the nozzle assembly 12 is at a downstream of the transmission channel 100, configured to heat the consumables, melting and extruding the consumables to achieve 3D printing. The nozzle assembly 12 includes a heat dissipation portion 121 and a nozzle portion 122, the heat dissipation portion 121 is detachably connected with the bracket 11, and the nozzle portion 122 is connected with the heat dissipation portion 121. The nozzle portion 122 is configured to heat a part of the consumables and melt them for extrusion, while the heat dissipation portion 121 is configured to dissipate heat from another part of the consumables to prevent premature melting that could cause material blockage.

In an embodiment, the heat dissipation portion 121 includes a heat dissipation main body 1211, heat dissipation fins 1212, a sliding platform 1213, and a connecting arm 1214, with the heat dissipation fins 1212, the sliding platform 1213, and the connecting arm 1214 respectively connected to the heat dissipation main body 1211. The heat dissipation main body 1211 is a main supporting structure of the heat dissipation portion 121, may be a block with a certain thickness along the sliding direction Y. The transmission channel 100 passes through the heat dissipation main body 1211 along the force application direction Z. The heat dissipation fins 1212 are configured to increase surface areas of the heat dissipation portion 121 to enhance heat dissipation effect, may be thin plates, with multiple heat dissipation fins 1212 disposed on opposite sides of the heat dissipation main body 1211 along the sliding direction Y and extending away from the heat dissipation main body 1211.

In an embodiment, the sliding platform 1213 is disposed at one end of the heat dissipation main body 1211 near the sliding portion 112 along the force application direction Z. The sliding platform 1213 includes a step structure protruding toward two sides of the heat dissipation main body 1211 along the side view direction X. The sliding platform 1213 extends along the sliding direction Y, achieving the heat dissipation portion 121 to slide along the sliding direction Y. One end of the connecting arm 1214 is connected with the heat dissipation main body 1211. The connecting arm 1214 extends along the force application direction Z and is provided around a periphery of the heat dissipation main body 1211 and heat dissipation fins 1212. The heat dissipation main body 1211 is disposed on the connecting arm 1214 on a side facing the plate portion 111 along the sliding direction Y. A thickness of the connecting arm 1214 may be same a thickness of the heat dissipation fins 1212, and the connecting arm 1214 may be configured for heat dissipation.

In an embodiment, the heat dissipation main body 1211 is configured to connect the nozzle portion 122, and the connecting arm 1214 connects the heat dissipation main body 1211 and the bracket 11. The sensor 13 is arranged on the connecting arm 1214, configured to sense deformation of the connecting arm 1214.

In an embodiment, the connecting arm 1214 includes a connection portion 12141 and a bending portion 12142. The connection portion 12141 is connected with the bracket 11, and the bending portion 12142 connects the heat dissipation main body 1211 and the connection portion 12141. The sensor 13 is arranged on the bending portion 12142, and an extension direction B of the bending portion 12142 intersects with the force application direction Z.

In an embodiment, the heat dissipation main body 1211 extends along the force application direction Z, the connection portion 12141 extends along the force application direction Z, and the bending portion 12142 is disposed on a side of the connection portion 12141 near the nozzle portion 122 along the force application direction Z. The connecting arm 1214 is disposed on one side of the heat dissipation main body 1211 along the sliding direction Y, the bending portion 12142 is disposed between the heat dissipation main body 1211 and the connection portion 12141 along the sliding direction Y, and an extension direction B of the bending portion 12142 is between the sliding direction Y and the force application direction Z.

In an embodiment, the connection portion 12141 and the plate portion 111 are substantially parallel, enabling good contact and fit between the connection portion 12141 and the plate portion 111, the extension direction B of the bending portion 12142 intersects with the extension direction of the heat dissipation main body 1211. The sensor 13 may be a device capable of sensing deformation, such as a strain gauge, piezoelectric ceramic sheet, pressure-sensitive resistor, or other components. The sensor 13 is electrically connected with a processor or signal sensor (such as a circuit board, not shown in the figure), the sensor 13 is able to sense displacement of the nozzle assembly 12, for coordinating operations such as positioning of the nozzle assembly 12.

During 3D printing process, the nozzle portion 122 of the nozzle assembly 12 may contact other structures (such as the forming platform 191 of the 3D printing device) along the force application direction Z, the contact may cause the nozzle portion 122 to be compressed or displaced along the force application direction Z. The heat dissipation portion 121 may have certain movement clearance relative to the fixing bolt 14 along the force application direction Z, and the heat dissipation portion 121 connected with the nozzle portion 122 may synchronously displace along the force application direction Z with the nozzle portion 122. The connection portion 12141 is fixedly connected with the plate portion 111 along the force application direction Z. When the heat dissipation main body 1211 displaces along the force application direction Z, movement occurs between the heat dissipation main body 1211 and the connection portion 12141 along the force application direction Z, two ends of the bending portion 12142 respectively connected to the heat dissipation main body 1211 and the connection portion 12141 receive forces in different directions, making the bending portion 12142 to deform under stretching. The sensor 13 disposed on the bending portion 12142 is able to generate corresponding sensing electrical signals by sensing the deformation of the bending portion 12142, the sensing electrical signal may be determined as a contact signal of the nozzle assembly 12.

In an embodiment, the sensor 13 may be a strain-type sensing unit, fiber Bragg grating sensing unit, piezoresistive sensing unit, or micro strain gauge sensing unit. Among them, the strain-type sensing unit is based on the principle that material's electrical resistance, capacitance, or inductance properties change with strain, typically includes elastic elements and sensitive elements (such as electrical resistance strain gauges), capable of converting mechanical strain into electrical signals for measurement. The fiber Bragg grating sensing unit applies grating structures in optical fibers to measure strain, featuring high resolution, strong anti-interference capability, and long-distance transmission ability. The piezoresistive sensing unit measures strain based on resistance value changes, characterized by low cost and ease of use. The micro strain gauge sensing unit is a high-precision sensor that may measure minute strain changes, typically having high sensitivity and low temperature influence. Those skilled in the art may help to understand that the sensor 13 may use known and feasible structures that is able to sense subtle deformation of the bending portion 12142, achieving detection of the contact signal of the nozzle assembly 12.

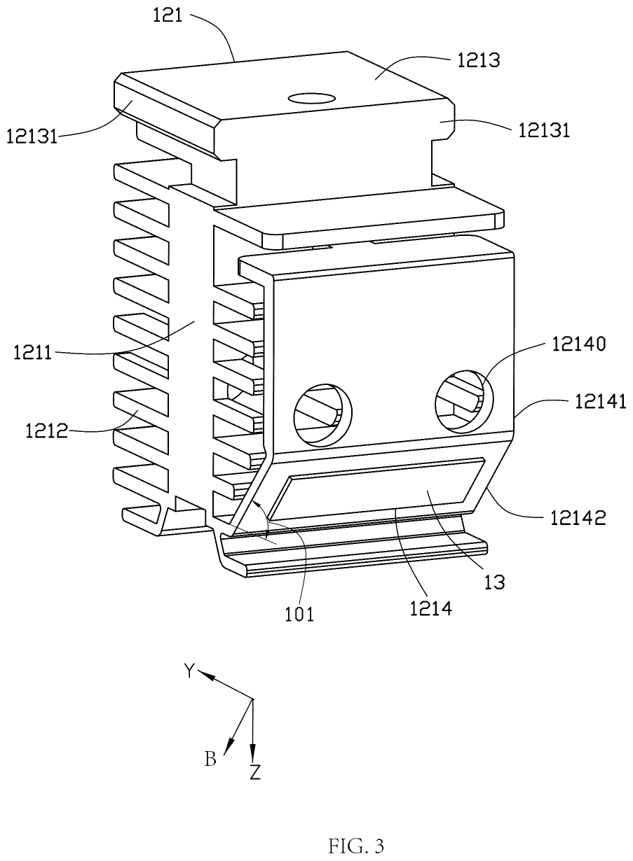

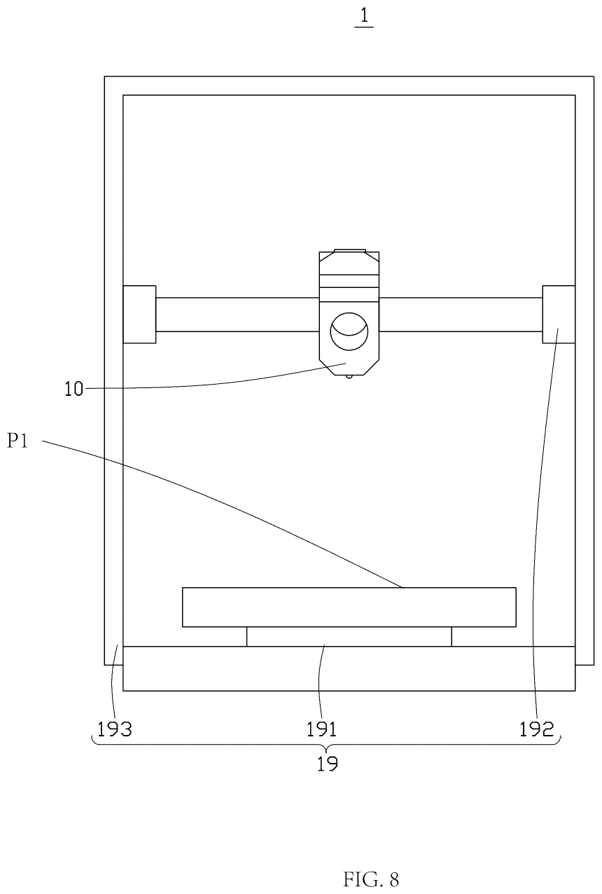

In an embodiment, further referring to FIG. 3 and FIG. 8, the extension direction B of the bending portion 12142 intersects with the extension direction of a plane P1 defined by the forming platform 191. An angle 101 between the extension direction B of the bending portion 12142 and the extension direction of the plane P1 defined by the forming platform 191 may be between 0° and 90° (excluding 0° and 90°), further may be between 20° and 70°, further may be between 30° and 60°, and further may be 45°.

When the extension direction B of the bending portion 12142 intersects with the extension direction of the plane P1 defined by the forming platform 191, a length of the bending portion 12142 is longer compared to when the bending portion 12142 is set parallel to the sliding direction Y or parallel to the force application direction Z, correspondingly, an area of the bending portion 12142 along its extension direction is larger. When the bending portion 12142 is compressed and deformed, the larger area of the bending portion 12142 may correspondingly have a greater amount of deformation, making it easier for the sensor 13 disposed on the bending portion 12142 to sense the deformation, improving sensing sensitivity.

In an embodiment, the bracket 11 is provided with a first mounting hole 1110 penetrating through the bracket 11 along the sliding direction Y, the connection portion 12141 is provided with a second mounting hole 12140 penetrating through the connection portion 12141 along the sliding direction Y, and the heat dissipation main body 1211 is provided with a third mounting hole 12110 penetrating through the heat dissipation main body 1211 along the sliding direction Y. The head set 10 further includes a fixing bolt 14, the fixing bolt 14 passes through the first mounting hole 1110, the second mounting hole 12140, and the third mounting hole 12110 along the sliding direction Y, and an outer diameter of the fixing bolt 14 is smaller than an inner diameter of the third mounting hole 12110.

In an embodiment, the heat dissipation main body 1211 is spaced apart from the plate portion 111 along the sliding direction Y, and the connecting arm 1214 is disposed between the heat dissipation main body 1211 and the plate portion 111 along the sliding direction Y. The first mounting hole 1110, second mounting hole 12140, and third mounting hole 12110 are at a same height along the force application direction Z, aligned and communicatively connected. The first mounting hole 1110 is defined on the plate portion 111, the second mounting hole 12140 is defined on the connection portion 12141, and the third mounting hole 12110 is defined on the heat dissipation main body 1211. The fixing bolt 14 passes through the first mounting hole 1110, second mounting hole 12140, and third mounting hole 12110 along the sliding direction Y to fix the plate portion 111, connecting arm 1214, and heat dissipation main body 1211. The outer diameter of the fixing bolt 14 is smaller than the inner diameter of the third mounting hole 12110, enabling the heat dissipation portion 121 to have certain movement clearance relative to the fixing bolt 14 along the force application direction Z. When the nozzle assembly 12 makes contact along the force application direction Z, the heat dissipation main body 1211 moves along the force application direction Z, while the connection portion 12141 remains fixed to the plate portion 111, making the bending portion 12142 connecting the heat dissipation main body 1211 and connection portion 12141 to deform under force, triggering the sensor 13 to generate sensing signals.

In an embodiment, there are two each of the first mounting hole 1110, second mounting hole 12140, and third mounting hole 12110, spaced apart in pairs along the side view direction X. In other embodiments, there may be multiple first mounting holes 1110, second mounting holes 12140, and third mounting holes 12110, which may be spaced apart respectively along the side view direction X. The fixing bolt 14 may be a bolt-type connection structure, passing through the first mounting hole 1110, second mounting hole 12140, and third mounting hole 12110 along the sliding direction Y to fix the plate portion 111, connecting arm 1214, and heat dissipation main body 1211.

The fixing bolt 14 is mechanically assembled with the first mounting hole 1110, second mounting hole 12140, and third mounting hole 1211. The outer diameter of the fixing bolt 14 may be smaller than the inner diameter of the first mounting hole 1110, second mounting hole 12140, and third mounting hole 12110. There is a movement clearance between the fixing bolt 14 and the first mounting hole 1110, second mounting hole 12140, and third mounting hole 12110 along the force application direction Z, allowing the heat dissipation main body 1211 to displace when compressed, correspondingly allowing the bending portion 12142 to deform and the sensor 13 to generate sensing signals.

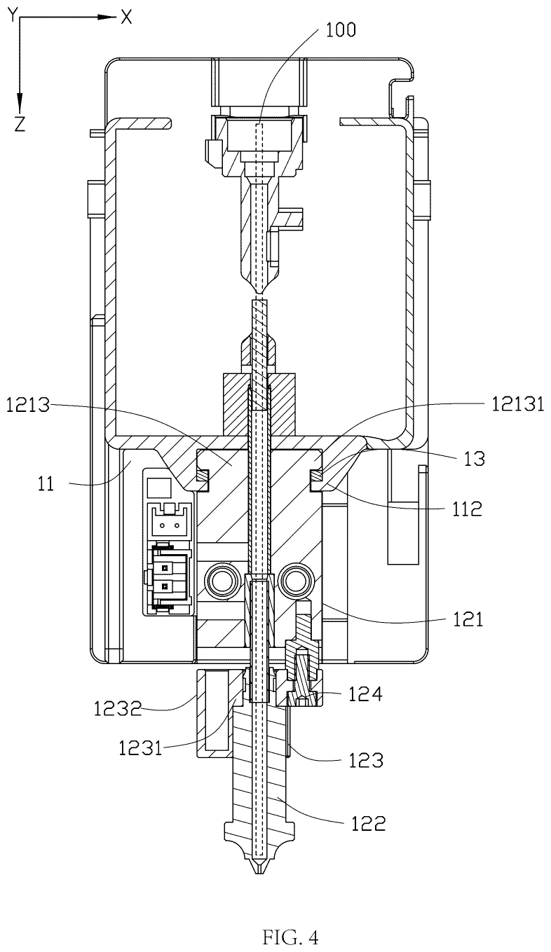

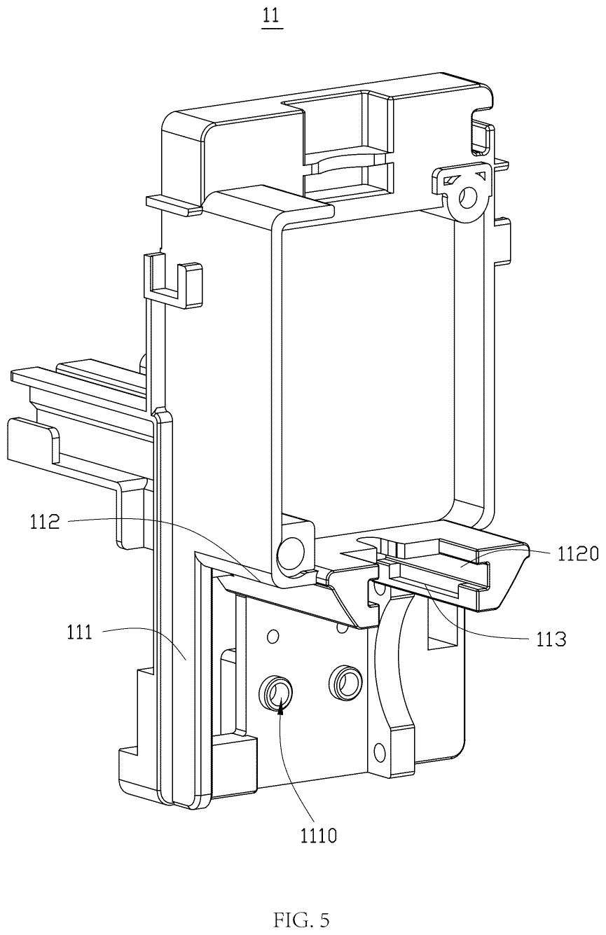

Further referring to FIG. 4 and FIG. 5, in an embodiment, the heat dissipation main body 1211 is configured to connect with the nozzle portion 122. The sliding platform 1213 is disposed at one end of the heat dissipation main body 1211 near the sliding portion 112 along the force application direction Z, and is slidably connected with the bracket 11. The sensor 13 is arranged between the sliding platform 1213 and the bracket 11, configured to sense displacement of the nozzle assembly 12.

In an embodiment, the sensor 13 is connected with the bracket 11 and detachably contacts the sliding platform 1213, or the sensor 13 is connected with the sliding platform 1213 and detachably contacts the bracket 11.

In an embodiment, the sliding platform 1213 includes a protruding platform 12131 protruding along the side view direction X. The sliding portion 112 is provided with a sliding groove 1120 recessed along the side view direction X, and the protruding platform 12131 is slidably disposed in the sliding groove 1120. The heat dissipation portion 121 is slidably disposed with the bracket 11 along the sliding direction Y.

In an embodiment, the sliding platform 1213 is positioned at the end of the heat dissipation main body 1211, the sliding platform 1213 includes two protruding platforms 12131, the two protruding platforms 12131 are respectively connected with the heat dissipation main body 1211 and protrude toward opposite sides along the side view direction X. The sliding portion 112 is provided with two spaced sliding grooves 1120 along the side view direction X. A cavity between the two sliding grooves 1120 along the side view direction X receives the sliding platform 1213 and the end of the heat dissipation main body 1211 connected with the sliding platform 1213, each of the two sliding grooves 1120 is configured to receive one protruding platform 12131. The protruding platform 12131 extends into the sliding groove 1120 along the side view direction X, the sliding platform 1213 is stacked with the sliding portion 112 along the force application direction Z to achieve support of the heat dissipation portion 121 by the bracket 11 along the force application direction Z, both the protruding platform 12131 and the sliding groove 1120 extend along the sliding direction Y, allowing the heat dissipation portion 121 to be slidably disposed with the sliding portion 112 along the sliding direction Y.

In an embodiment, the sliding portion 112 is provided with a receiving groove 113 on a side facing the protruding platform 12131 along the force application direction Z, the receiving groove 113 is configured to receive the sensor 13. The receiving groove 113 includes an opening on a side facing the protruding platform 12131 along the force application direction Z, the opening enables the sensor 13 to be exposed by the receiving groove 113, achieving the sensor 13 to directly contact or cooperate with the protruding platform 12131 on the side facing the protruding platform 12131 along the force application direction Z.

In an embodiment, the receiving groove 113 may be formed by material removal from the sliding portion 112 or formed integrally. The receiving groove 113 includes one opening on the side facing the protruding platform 12131 along the force application direction Z, or includes one opening on the side facing the heat dissipation main body 1211 along the side view direction X, or includes openings on both the side facing the heat dissipation main body 1211 along the side view direction X and the side facing the protruding platform 12131 along the force application direction Z. A part of the sensor 13 arranged in the receiving groove 113 is fixed and limited on both sides of the receiving groove 113 along the sliding direction Y, a side of the sense 13 facing the heat dissipation main body 1211 along the side view direction X or a side of the sensor 13 facing the protruding platform 12131 along the force application direction Z exposed and directly facing the heat dissipation portion 121.

In one implementation, the sensor 13 may be a pressure sensing unit; after the protruding platform 12131 and sliding groove 1120 are assembled, the nozzle assembly 12 tends to press downward along the force application direction Z due to its own weight, and the sensor 13 bears the downward force from the protruding platform 12131. During 3D printing process, the nozzle assembly 12 may contact other structures (such as the forming platform 191 or base of the 3D printing device) along the force application direction Z, the contact makes the nozzle assembly 12 to receive a reverse supporting force along the force application direction Z, correspondingly reducing the force applied by the protruding platform 12131 to the sensor 13 along the force application direction Z, and the sensor 13 senses the force change and generates corresponding sensing signals.

In an embodiment, the plate portion 111 and the nozzle assembly 12 are arranged side by side along the force application direction Z. The sliding portion 112 is connected with the plate portion 111 and protruding along the sliding direction. The nozzle assembly 12 is arranged on one side of the sliding portion 112 along the force application direction Z, the sliding platform 1213 is staggered with and slidably connected to the sliding portion 112 along the force application direction Z, and the sensor 13 is arranged between the sliding platform 1213 and the sliding portion 112.

In an embodiment, the sliding portion 112 is disposed on one side of the plate portion 111 along the sliding direction Y, and the nozzle assembly 12 is disposed on one side of the sliding portion 112 along the force application direction Z. The sliding platform 1213 is disposed at the end of the heat dissipation portion 121 along the force application direction Z, the connecting arm 1214 extends along the force application direction Z, and the connecting arm 1214 is detachably connected with the plate portion 111. The sliding platform 1213 is disposed on the side of the heat dissipation portion 121 facing the sliding portion 112, the connecting arm 1214 is disposed on the side of the heat dissipation portion 121 facing the plate portion 111. When the sliding platform 1213 cooperates with the sliding portion 112 to slide the heat dissipation portion 121 to a predetermined position along the sliding direction Y, at least part of the connecting arm 1214 extending along the force application direction Z abuts against the plate portion 111 and connects the plate portion 111 through other fixing structures, fixing the heat dissipation portion 121 with the plate portion 111.

The plate portion 111 and the nozzle assembly 12 are arranged side by side along the force application direction Z, facilitates the installation of the heat dissipation portion 121 with the bracket 11 and decreases influence of the plate portion 111 on the deformation, displacement, or force applied to the nozzle assembly 12.

In other embodiments, the sensor 13 may be arranged on the upstream or downstream side of the protruding platform 12131 facing the sliding portion 112 along the force application direction Z. When the nozzle assembly 12 receives a reverse supporting force along the force application direction Z, the pressure applied to the sensor 13 by the sensor 13 and/or sliding portion 112 may correspondingly change, and the sensor 13 is able to sense the force change and generate corresponding sensing signals.

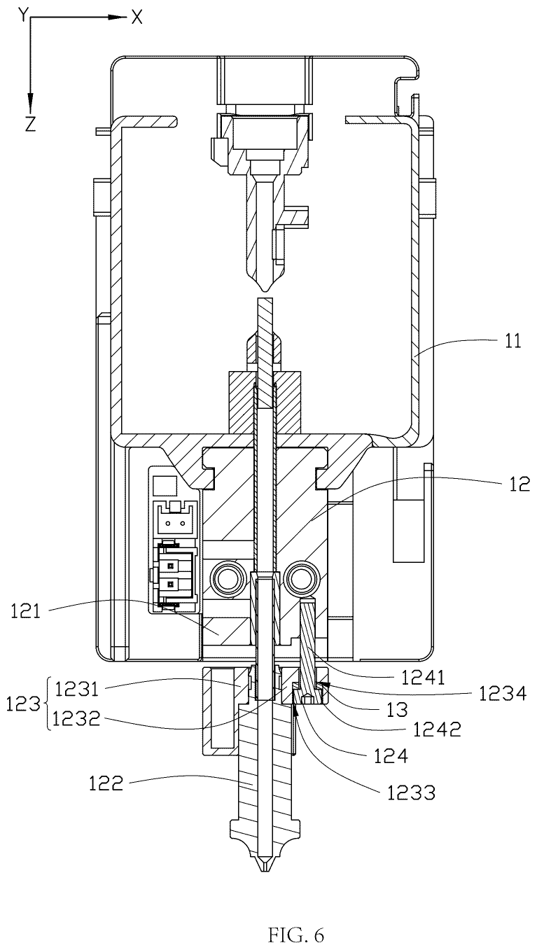

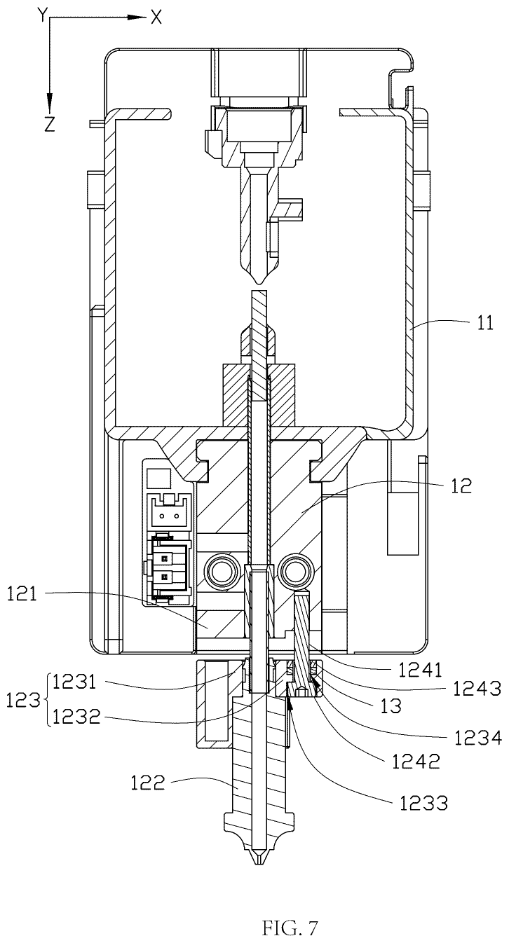

Further referring to FIG. 6 and FIG. 7, in an embodiment, the heat dissipation portion 121 is configured to connect with the bracket 11, the nozzle portion 122 is connected with the heat dissipation portion 121, and is disposed on the side of the heat dissipation portion 121 away from the bracket 11 along the force application direction Z. The sensor 13 is arranged between the heat dissipation portion 121 and the nozzle portion 122, configured to sense displacement of the nozzle assembly 12.

In an embodiment, an isolation sleeve 123 is connected with the nozzle portion 122, and a connecting post 124 connects the isolation sleeve 123 with the heat dissipation portion 121. The connecting post 124 is movably connected with the isolation sleeve 123, and a gap 1234 is formed at a connection between the connecting post 124 and the isolation sleeve 123, and a size of the gap 1234 is variable along the force application direction Z in response to the connecting post is moved to connect with the isolation sleeve 123. The sensor 13 is arranged in the gap 1234, detachably contacting the isolation sleeve 123 and/or the connecting post 124, configured to sense displacement of the nozzle assembly 12.

In an embodiment, the isolation sleeve 123 includes a first portion 1231 and a second portion 1232 connected with the first portion 1231, the first portion 1231 is configured to receive and connect the nozzle portion 122, the second portion 1232 extends from the first portion 1231 toward the transmission channel 100. The second portion 1232 is provided with a mounting cavity 1233, one end of the connecting post 124 is disposed in the mounting cavity 1233 and connected with the second portion 1232 through snap-fitting, threaded connection, abutting limitation or other methods; and an other end of the connecting post 124 is connected with the heat dissipation portion 121 through snap-fitting, threaded connection, abutting limitation or other methods.

In an embodiment, the sensor 13 may be a contact-type sensor with high-temperature resistance, such as a ceramic piezoelectric sensor or a capacitive sensor. The capacitive sensor 13 measures strain based on changes in capacitance values, featuring high sensitivity and low temperature influence.

The sensor 13 arranged between the heat dissipation portion 121 and the nozzle portion 122 is relatively close to the nozzle portion 122 which has relatively high temperature, and may be subject to continuous high-temperature influence during operation. Selecting a sensor 13 with high-temperature resistance may enhance reliability of the head set 10.

Further referring to FIG. 6, in an embodiment, the connecting post 124 includes a post body 1241 and a cap body 1242, the cap body 1242 is connected to a side of the post body 1241 near the nozzle portion 122 along the force application direction Z, the post body 1241 passes through the second portion 1232 along the force application direction Z, and an end of the post body 1241 away from the cap body 1242 along the force application direction Z extends to connect with the heat dissipation portion 121. The sensor 13 is fitted around the outside of the post body 1241 and sandwiched between the cap body 1242 and the second portion 1232 along the force application direction Z. The sensor 13 is able to receive force applied by the connecting post 124 and/or isolation sleeve 123 along the force application direction Z. During 3D printing process, the nozzle assembly 12 may contact other structures (such as the forming platform 191 or base of the 3D printing device) along the force application direction Z, the contact may cause the nozzle assembly 12 to receive a reverse supporting force along the force application direction Z, the force applied to the sensor 13 by the connecting post 124 and/or isolation sleeve 123 along the force application direction Z correspondingly changes (increases or decreases), and the sensor 13 senses this force change and generates corresponding sensing signals.

Further referring to FIG. 7, in an embodiment, the connecting post 124 includes the post body 1241, the cap body 1242, and a ring body 1243, the cap body 1242 is connected to a side of the post body 1241 near the nozzle portion 122 along the force application direction Z, the post body 1241 passes through the second portion 1232 along the force application direction Z, the end of the post body 1241 away from the cap body 1242 along the force application direction Z extends to connect with the heat dissipation portion 121, and the ring body 1243 is arranged on an outside of the post body 1241 and is between the nozzle portion 122 and the heat dissipation portion 121. The sensor 13 is fitted around the outside of the post body 1241 and sandwiched between the ring body 1243 and the second portion 1232 along the force application direction Z. The sensor 13 is able to receive force applied by the connecting post 124 and/or isolation sleeve 123 along the force application direction Z. During 3D printing process, the nozzle assembly 12 may contact other structures (such as the forming platform 191 or base of the 3D printing device) along the force application direction Z, the contact will cause the nozzle assembly 12 to receive a reverse supporting force along the force application direction Z, the force applied to the sensor 13 by the connecting post 124 and/or isolation sleeve 123 along the force application direction Z correspondingly changes (increases or decreases), and the sensor 13 senses this force change and generates corresponding sensing signals.

In some embodiments, the sensor 13 may be electrically connected with a processor or signal sensing unit (such as a circuit board, not shown in the figure) of the head set 10. According to different mounting positions of the sensor 13, clearance structures such as openings (not shown in the figure) may be provided at different positions of the bracket 11, and conductive wiring may be configured to connect the sensor 13 with the processor or signal sensing unit, or wireless transmission may be configured to achieve communication connection between the sensor 13 and the processor or signal sensing unit. Specific model of the sensor 13 and its form of electrical connection with the processor or signal sensing unit can adopt known and feasible methods, which will not be elaborated here.

Further referring to FIG. 8, embodiments of the present application further provide a 3D printing device 1, the 3D printing device 1 includes a 3D printing main body 19 and a head set 10 as described in any of the previous embodiments, with the head set 10 connected to the 3D printing main body 19.

In an embodiment, the 3D printing main body 19 includes a forming platform 191, an X-axis drive assembly 192, and a gantry 193, the forming platform 191 and the X-axis drive assembly 192 are respectively connected with the gantry 193, the head set 10 is movably connected with the X-axis drive assembly 192, and the head set 10 is able to move relative to the forming platform 191 to perform 3D printing.

In an embodiment, the present application further provides a 3D printing method, including the following steps:
Step S1: Selecting a file of a model configured for printing.
Step S2: Obtaining coordinates of a lowest area and a highest area of the model according to the file.
Step S3: Leveling and obtaining an inclination angles of the forming platform 191 in the side view direction X and sliding direction Y.
Step S4: Printing the model.

In an embodiment, during Step S3, the head set 10 and/or 3D printing device 1 provided by embodiments of the present application achieve leveling by making multiple contacts between the head set 10 and multiple points on the corresponding forming platform 191 along the force application direction Z.

The head set 10 is driven to move toward the forming platform 191 along the force application direction Z until the nozzle portion 122 contacts the forming platform 191 (specifically can be a heat bed). After contact, the head set 10 is driven to continue moving along the force application direction Z and compress the forming platform 191, and the forming platform 191 applies a reverse reaction force toward the nozzle portion 122, compressing the nozzle portion 122 to move in the reverse direction along the force application direction Z. For the head set 10 shown in FIG. 1 to FIG. 3 and the 3D printing device 1 applying the head set 10, the nozzle portion 122 is connected with the heat dissipation main body 1211 and moves in the reverse direction along the force application direction Z under compression, the bending portion 12142 is connected with the heat dissipation main body 1211 and receives force, the connection portion 12141 is connected with the bending portion 12142 and fixed to the bracket 11. The bending portion 12142 generates torsional deformation due to uneven forces at both ends, the sensor 13 arranged on the bending portion 12142 senses the deformation of the bending portion 12142 and generates corresponding sensing electrical signals, which correspond to the contact signal of the nozzle assembly 12.

The head set 10 and/or 3D printing device 1 provided by embodiments of the present application amplifies deformation through the setup of the inclined bending portion 12142, enabling the bending portion 12142 to generate sufficient deformation that can be sensed by the sensor 13 even when the mutual compression force between the nozzle portion 122 and the forming platform 191 is relatively small, making the sensor 13 to generate sensing electrical signals earlier. The head set 10 and/or 3D printing device 1 of the present application amplifies deformation through the setup of the bending portion 12142, enabling earlier detection of the trigger point of sudden force change (the point of generating sensing electrical signals).

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A head set configured to be driven to move along a force application direction, the head set comprising:
a bracket;
a nozzle assembly connected with the bracket and configured to be driven to move along the force application direction; and
a sensor connected with the bracket and/or the nozzle assembly, configured to sense a displacement and/or a deformation of the nozzle assembly.

2. The head set according to claim 1, wherein the nozzle assembly comprises a heat dissipation portion and a nozzle portion, the heat dissipation portion comprises:
a heat dissipation main body configured to connect the nozzle portion;
a connecting arm connecting the heat dissipation main body and the bracket;
wherein the sensor is arranged on the connecting arm and configured to sense a deformation of the connecting arm.

3. The head set according to claim 2, wherein the connecting arm comprises:
a connection portion connected with the bracket;
a bending portion connecting the connection portion and the heat dissipation main body;
wherein the sensor is arranged on the bending portion, and an extension direction of the bending portion intersects with the force application direction.

4. The head set according to claim 3, wherein:
the heat dissipation main body extends along the force application direction;
the connection portion extends along the force application direction, and the bending portion is disposed on a side of the connection portion near the nozzle portion along the force application direction;
the connecting arm is disposed on one side of the heat dissipation main body along a sliding direction, the bending portion is disposed between the heat dissipation main body and the connection portion along the sliding direction;
the sliding direction intersects with the force application direction, and the extension direction of the bending portion is between the sliding direction and the force application direction.

5. The head set according to claim 3, wherein:
the bracket defined a first mounting hole, the first mounting hole penetrates through the bracket along a sliding direction;
the connection portion defines a second mounting hole, the second mounting hole penetrates through the connection portion along the sliding direction; and
the heat dissipation main body defines a third mounting hole, the third mounting hole penetrates through the heat dissipation main body along the sliding direction;
the head set further comprises a fixing bolt, the fixing bolt passes through the first mounting hole, the second mounting hole, and the third mounting hole along the sliding direction, and an outer diameter of the fixing bolt is smaller than an inner diameter of the third mounting hole.

6. The head set according to claim 1, wherein the nozzle assembly comprises a heat dissipation portion and a nozzle portion, the heat dissipation portion comprises:
a heat dissipation main body, configured to connect the nozzle portion;
a sliding platform disposed at one end of the heat dissipation main body along the force application direction, and the sliding platform is slidably connected with the bracket,
wherein the sensor is arranged between the sliding platform and the bracket, configured to sense a displacement of the nozzle assembly.

7. The head set according to claim 6, wherein the sensor is connected with the bracket and detachably contacts the sliding platform.

8. The head set according to claim 6, wherein the sensor is connected with the sliding platform and detachably contacts the bracket.

9. The head set according to claim 6, wherein the bracket comprises:
a plate portion, wherein the plate portion and the nozzle assembly are arranged side by side along the force application direction;
a sliding portion connected with the plate portion and protruding along the sliding direction;
wherein the nozzle assembly is arranged on one side of the sliding portion along the force application direction, the sliding platform is staggered with and slidably connected to the sliding portion along the force application direction, and the sensor is arranged between the sliding platform and the sliding portion.

10. The head set according to claim 1, wherein the nozzle assembly comprises:
a heat dissipation portion configured to connect with the bracket;
a nozzle portion connected with the heat dissipation portion, and disposed on a side of the heat dissipation portion away from the bracket along the force application direction;
wherein the sensor is arranged between the heat dissipation portion and the nozzle portion, and is configured to sense the displacement of the nozzle assembly.

11. The head set according to claim 9, wherein the nozzle assembly further comprises:
an isolation sleeve connected with the nozzle portion;
a connecting post connecting the isolation sleeve with the heat dissipation portion,
wherein the connecting post is movably connected with the isolation sleeve, and a gap is formed at a connection between the connecting post and the isolation sleeve, a size of the gap is variable along the force application direction in response to the connecting post is moved to connect with the isolation sleeve;
wherein the sensor is arranged in the gap, detachably contacting the isolation sleeve and/or the connecting post, and is configured to sense the displacement of the nozzle assembly.

12. The head set according to claim 11, wherein the isolation sleeve comprises a first portion and a second portion connected with the first portion, the first portion is configured to receive and connect the nozzle portion, the second portion defined a mounting cavity, one end of the connecting post is disposed in the mounting cavity and connected with the second portion, and another end of the connecting post is connected with the heat dissipation portion.

13. The head set according to claim 12, wherein the connecting post comprises a post body and a cap body, the cap body is connected to a side of the post body near the nozzle portion along the force application direction, the post body passes through the second portion along the force application direction, and an end of the post body away from the cap body along the force application direction extends to connect with the heat dissipation portion.

14. The head set according to claim 12, wherein the sensor is fitted around an outside of the post body and sandwiched between the cap body and the second portion along the force application direction.

15. The head set according to claim 9, wherein the sliding portion defines a receiving groove, the receiving groove is configured to receive the sensor.

16. The head set according to claim 9, wherein the head set further comprise an extrusion assembly connected with the bracket, the extrusion assembly and the nozzle assembly are arranged on opposite sides of the sliding portion along the force application direction.

17. A 3D printing device comprising:
a 3D printing main body;
and the head set according to claim 1, wherein the head set is connected to the 3D printing main body.

18. The 3D printing device according to claim 17, wherein the 3D printing main body comprises a forming platform defining a plane, the head set is moveable relative to the forming platform, an extension direction of a bending portion of the nozzle assembly intersects with the plane defined by the forming platform.

19. The 3D printing device according to claim 18, wherein an angle between the extension direction of the bending portion and the plane defined by the forming platform is between 0° and 90°.

20. A 3D printing method, the 3D printing method is applied in the 3D printing device according to claim 17, wherein the 3D printing method comprising:
selecting a file of a model configured for printing;
obtaining coordinates of a lowest area and a highest area of the model according to the file;
leveling and obtaining an inclination angles of the forming platform in a side view direction and a sliding direction; and
printing the model.
